(19) United States
(12) Patent Application Publication
(10) Pub. No.: US 2024/0339740 A1
(43) Pub. Date: Oct. 10, 2024

(54) Electrolyte Infiltration Method and Apparatus for Pouch Cell, and Electrolyte Injection Machine

(71) Applicants: Microvast Power Systems Co., Ltd., Huzhou (CN); Microvast, Inc., Stafford, TX (US)

(72) Inventors: Dengkai HU, Huzhou (CN); Yingying ZOU, Huzhou (CN); Yongcun LIU, Huzhou (CN)

(21) Appl. No.: 18/626,071

(22) Filed: Apr. 3, 2024

(30) Foreign Application Priority Data
Apr. 4, 2023 (CN) 202310353486.6

(51) Int. Cl. H01M 50/618; H01M 50/105

(52) U.S. Cl. CPC H01M 50/618; H01M 50/105

(57) ABSTRACT

An electrolyte infiltration method and apparatus for a pouch cell, and an electrolyte injection machine are provided. The electrolyte infiltration method for the pouch cell includes: S1, a cell assembly after electrolyte injection is placed in a closed environment, and a cell gas pocket is in an open state; S2, the closed environment is disposed to a first vacuum value, and then an opening of the cell gas pocket is sealed; S3, the closed environment is set to a second vacuum value, a pressure is maintained, and the second vacuum value is lower than the first vacuum value; S4, the closed environment is set to be a normal pressure, and the pressure is maintained; S5, S3 and S4 are repeated, and the opening of the cell gas pocket is opened; and S6, the closed environment is set to a third vacuum value, and the cell gas pocket is sealed.

### CROSS-REFERENCE TO RELATED APPLICATION

The present disclosure claims priority to Chinese Patent Application No. 202310353486.6, filed on Apr. 4, 2023 and entitled “Electrolyte Infiltration Method and Apparatus for Pouch Cell, and Electrolyte Injection Machine”, the contents of which are hereby incorporated by reference in its entirety.

### TECHNICAL FIELD

The disclosure relates to the technical field of secondary batteries, in particular to an electrolyte infiltration method and apparatus for a pouch cell, and an electrolyte injection machine.

### BACKGROUND

A pouch cell is widely used because of its high energy density and good security.

While after the pouch cell with high energy density and large volume is filled with electrolyte, it is difficult for an electrode sheet with active materials, especially the electrode sheet in a middle of the cell, to absorb the electrolyte, and the cell needs to be stored for a certain time in order to be absorbed by the electrode sheet better.

At present, a method of directly vacuumizing an interior of a cell assembly and then sealing or directly opening for a certain time under vacuum and then sealing after electrolyte injection is adopted in the industry, and the cell may be stored for 1 to 2 days at high temperature or normal temperature after being sealed so as to realize full infiltration of the electrolyte.

But only by slow permeation of the electrolyte into the electrode sheet from the edge, not only the electrolyte permeation speed is low, but the electrolyte permeation effect is unsatisfactory, and the middle of the cell may still be in a dry state after electrolyte injection for several hours.

### SUMMARY

A main objective of the disclosure is to provide an electrolyte infiltration method and apparatus for a pouch cell, and an electrolyte injection machine, which may improve the electrolyte infiltration speed of the cell and improve the electrolyte permeation effect of the cell.

In a first aspect, this disclosure provides an electrolyte infiltration method for a pouch cell, which includes the following operations in sequence.

In S1, a cell assembly after electrolyte injection is placed in a closed environment, and a cell gas pocket is enabled to be in an open state.

In S2, the closed environment is set to a first vacuum value, and then the cell gas pocket is closed.

In S3, the closed environment is set to a second vacuum value, a pressure with the second vacuum value is maintained, and the second vacuum value is lower than the first vacuum value.

In S4, the closed environment is set to a normal pressure, and the normal pressure is maintained.

In S5, S3 and S4 are repeated to a set number of times, and the cell gas pocket is opened.

In S6, the closed environment is set to a third vacuum value, and an opening of the cell gas pocket is sealed.

As an implementation mode, the closed environment is a vacuum device.

As an implementation mode, a pressure difference between the second vacuum value and the first vacuum value is smaller than a maximum deformation allowable force of a cell case.

As an implementation mode, a difference range of the second vacuum value and the first vacuum value is from 10 KPa to 80 KPa.

As an implementation mode, in S2, the first vacuum value of the closed environment is ranging from −10 KPa to −50 KPa.

As an implementation mode, in S3, the second vacuum value of the closed environment is ranging from −20 KPa to −90 KPa.

As an implementation mode, in S6, the third vacuum value of the closed environment is ranging from −80 KPa to −100 KPa.

As an implementation mode, in S3, the pressure holding time is 0-120 s, or, the pressure holding time is 5 s-100 s, or the pressure holding time is 10 s-80 s, or the pressure holding time is 20 s-60 s.

As an implementation mode, in S4, the pressure holding time is 0-120 s, or, the pressure holding time is 5 s-100 s, or the pressure holding time is 10 s-80 s, or the pressure holding time is 20 s-60 s.

As an implementation mode, in S5, the set number of times is 0-10 times, or the set number of times is 1-8 times, or the set number of times is 2 times −5 times.

As an implementation mode, in S6, a sealing temperature is ranging from 165° C. to 195° C., and the sealing time is 2 s-7 s.

In an implementation mode, S6 includes the following operations. The opening of the cell gas pocket is sealed; or, first, the cell gas pocket is clamped, and then the opening of the cell gas pocket is sealed.

In a second aspect, this disclosure provides an infiltration apparatus applied to the electrolyte infiltration method for the pouch cell, which includes: the closed environment having a sealed cavity configured to accommodate the cell assembly; and splint cylinders, disposed on two opposite sides of the closed environment, each of the splint cylinders includes a cylinder and a splint, the splint is disposed at a telescopic end of the cylinder, and located in the sealed cavity, and two splints disposed oppositely are configured for clamping or releasing the opening of the cell gas pocket.

As an implementation mode, a clamping area of the splint is any area of the cell gas pocket.

As an implementation mode, a soft material layer attaches to the surface of the splint.

As an implementation mode, the closed environment is defined by side plates, a top plate and a bottom plate.

As an implementation mode, the splint cylinders are disposed on the side plates.

As an implementation mode, the side plates include a rear side plate, a front side plate, a right side plate and a left side plate, and the splint cylinders are disposed on the left side plate and the right side plate.

As an implementation mode, the left side plate and the right side plate are further provided with sealing head cylinders which are symmetrically disposed and configured for sealing the cell gas pocket.

As an implementation mode, a telescopic end of the sealing head cylinder is provided with a sealing head base, the sealing head base is fixedly with a heating block and a sealing head, and the heating block is configured for heating the sealing head.

As an implementation mode, the infiltration apparatus also includes a lifting mechanism, the lifting mechanism includes a lifting cylinder and a guide rod, and the closed environment is able to slide along the guide rod under an action of the lifting cylinder.

As an implementation mode, a bottom of the sealed cavity of the closed environment is provided with a cell fixing groove for placing the cell assembly.

In the third aspect, this disclosure provides an electrolyte injection machine, which includes an electrolyte injection needle and the infiltration apparatus, and the electrolyte injection needle is connected to the closed environment of the infiltration apparatus.

With the adoption of the technical solution of the disclosure, the electrolyte infiltration method for the pouch cell includes: In S1, a cell assembly after electrolyte injection is placed in the closed environment, and the cell gas pocket is enabled to be in an open state; in S2, the closed environment is set to the first vacuum value, and then an opening of the cell gas pocket is sealed; in S3, the closed environment is set to the second vacuum value, a pressure is maintained, and the second vacuum value is lower than the first vacuum value; in S4, the closed environment is set to a normal pressure, and the pressure is maintained; in S5, S3 and S4 are repeated to a set number of times, and the opening of the cell gas pocket is opened; and in S6, the closed environment is set to a third vacuum value, and the opening of the cell gas pocket is sealed. Through the above electrolyte infiltration method for the pouch cell, the cell after electrolyte injection may be sealed after a certain vacuum is extracted, then repeated operations of vacuumizing and vacuum-draining are carried out on an outside of the cell, so that the cell itself may expand and contract in a reciprocating cycle, producing an effect of an exhalation and an inhalation and accelerating an infiltration of a middle electrode sheet of the cell, through repeated expansion and extrusion for the cell, an electrolyte infiltration speed of the cell is effectively improved, an electrolyte penetration effect of the cell is improved, a storage time at room temperature or high temperature carried out for the electrolyte to infiltrate the electrode sheet after electrolyte injection and sealing of the cell is obviously shortened, further, a production cycle of the cell is shortened, a standing process after electrolyte injection is selectively canceled, then a manufacturing cost of the device is reduced, a space of the device is saved, and a production efficiency is improved.

### BRIEF DESCRIPTION OF THE DRAWINGS

The accompanying drawings, which constitute a part of the disclosure, are used to provide a further understanding of the disclosure, and the exemplary embodiments of the disclosure and the description thereof are used to explain the disclosure, but do not constitute improper limitations to the disclosure. In the drawings:

FIG. 1 illustrates a flowchart of an electrolyte infiltration method for a pouch cell according to an embodiment of the disclosure.

FIG. 2 illustrates a schematic diagram of a front view of an infiltration apparatus according to an embodiment of the disclosure.

FIG. 3 illustrates a schematic diagram of a top view of an infiltration apparatus according to an embodiment of the disclosure.

FIG. 4 illustrates a schematic diagram of an internal structure of an infiltration apparatus according to an embodiment of the disclosure.

FIG. 5 illustrates a schematic diagram of an explosive view of a vacuum device of an infiltration apparatus according to an embodiment of the disclosure.

FIG. 6 illustrates a schematic diagram of a cell assembly according to an embodiment of the disclosure.

The drawings include the following reference signs. 1. Lifting cylinder; 2. Guide rod; 3. Closed environment; 4. Sealing head cylinder; 5. Splint cylinder; 6. Support plate; 7. Bottom plate; 8. Sealing head base; 9. Heating block; 10. Sealing head; 11. Splint; 12. Soft material layer; 13. Cell; 14. Cell fixing groove; 31. Rear side plate; 32. Front side plate; 33. Right side plate; 34. Left side plate; 35. Top plate; 131. Cell gas pocket; 132. Sealing area; 133. Clamping area; and 134. Cell case.

### DETAILED DESCRIPTION OF THE EMBODIMENTS

It is to be noted that the embodiments and features in the embodiments of the disclosure may be combined with each other without conflict. The disclosure will now be described in detail with reference to the accompanying drawings and the embodiments.

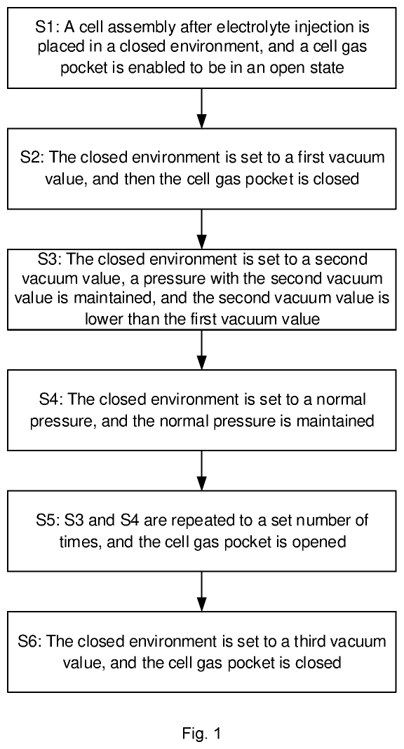

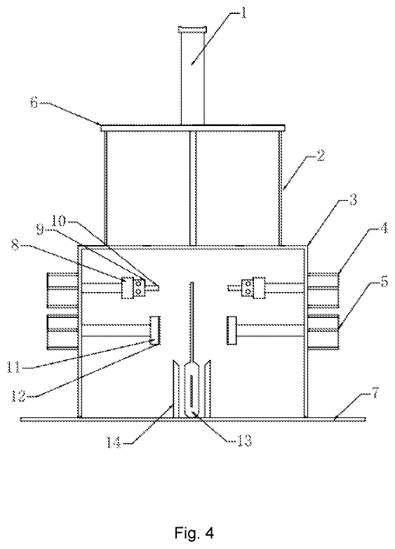

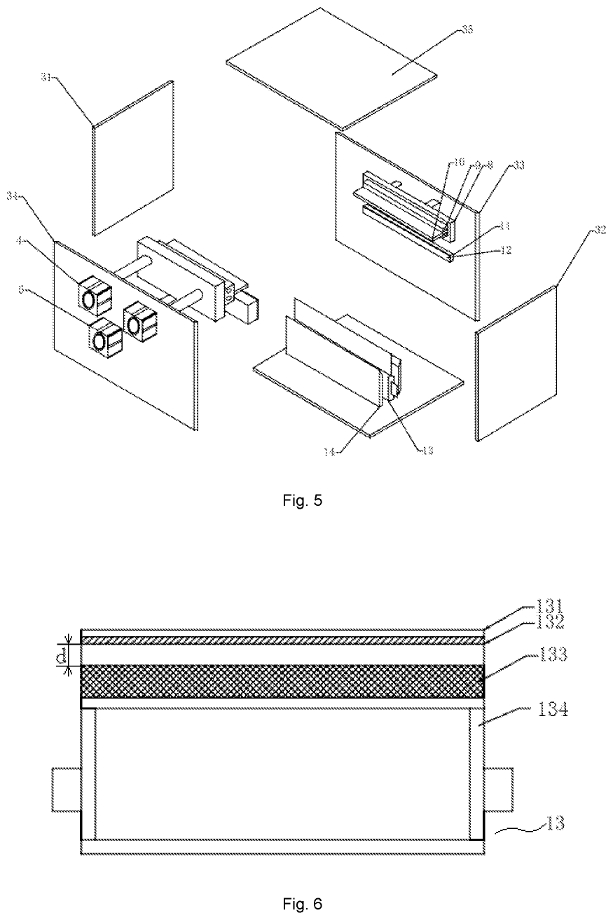

Referring to FIGS. 1-6, according to the embodiments of the disclosure, an electrolyte infiltration method for a pouch cell includes the following operations.

In S1, a cell assembly after electrolyte injection is placed in a closed environment 3, and a cell gas pocket 131 is enabled to be in an open state.

In S2, the closed environment 3 is set to a first vacuum value, and then the cell gas pocket 131 is closed.

In S3, the closed environment 3 is set to a second vacuum value, a pressure with the second vacuum value is maintained, and the second vacuum value is lower than the first vacuum value.

In S4, the closed environment 3 is set to a normal pressure, and the normal pressure is maintained.

In S5, S3 and S4 are repeated to a set number of times, and the cell gas pocket 131 is opened.

In S6, the closed environment 3 is set to a third vacuum value, and an opening of the cell gas pocket 131 is sealed.

In the embodiment, a cell 13 includes an internal cell body and a cell case 134, the internal cell body is disposed in the cell case 134, and a side, not provided with the internal cell body, of the cell case 134 is the cell gas pocket 131. The internal cell body has an electrode sheet, after electrolyte is injected into the cell case 134, the electrolyte infiltrates the internal cell body, so that the electrode sheet of the internal cell body may fully contact the electrolyte to achieve infiltration.

In the disclosure, the cell 13 after electrolyte injection is placed in the closed environment 3, then a certain vacuum is extracted for the closed environment 3, then the cell gas pocket 131 is sealed, then repeated operations of vacuumizing and vacuum-draining are carried out on the closed environment 3 after sealing, so that the cell 13 itself may expand and contract in a reciprocating cycle, producing an effect of an exhalation and an inhalation and accelerating an infiltration of the electrode sheet of the cell, and an electrolyte infiltrates to a middle of the electrode sheet. Through repeated expansion and extrusion for the cell 13, an electrolyte infiltration speed of the cell is effectively improved, an electrolyte penetration effect of the cell is improved, a storage time at room temperature or high temperature carried out for the electrolyte to infiltrate the electrode sheet after electrolyte injection and sealing of the cell 13 is obviously shortened, further, a production cycle of the cell is shortened, a standing process after electrolyte injection is selectively canceled, then a manufacturing cost of the device is reduced, a space of the device is saved, and a production efficiency is improved.

After electrolyte injection of the cell, the cell 13 is not clamped first, so that in the process of vacuuming in the closed environment 3, a certain vacuum is indirectly extracted from an interior of the cell 13 to maintain a certain negative pressure inside the cell, and then the cell 13 is clamped through splints, namely, the cell gas pocket 131 of the cell 13 is closed. Then the closed environment 3 outside the cell 13 is vacuumized, in such a case, an external vacuum value of the cell 13 is less than an internal vacuum value of cell 13 since the cell 13 is sealed, so that the cell case 134 expands, making the electrolyte flow more easily to a center of the cell, which is more conducive to an infiltration of the middle electrode sheet.

After holding for a certain time, the closed environment 3 outside the cell 13 is subjected to vacuum-draining, since the cell 13 is still in a sealed state, a vacuum value of the closed environment 3 outside the cell 13 is greater than a vacuum value inside the cell 13, so that the cell case 134 is compressed, making the electrolyte more fully infiltrate a middle electrode sheet of the internal cell body.

The above steps are repeated for several times, the middle electrode sheet of the internal cell body of the cell 13 fully contacts the electrolyte, thus an electrolyte permeation speed is accelerated, meanwhile, the storage time at room temperature or high temperature after sealing may be reduced, and the production cycle of the cell may be shortened. The temperature of high temperature is (0° C., 20° C.] higher than the temperature of room temperature.

In an embodiment, the closed environment 3 is a vacuum device. The vacuum device, for example, is a vacuum box.

In an embodiment, a pressure difference between the second vacuum value and the first vacuum value is smaller than a maximum deformation allowable force of the cell case.

In the embodiment, an expansion force of the cell case comes from the pressure difference between the first vacuum value and the second vacuum value, an extrusion force of the cell case comes from the pressure difference between the normal pressure and the first vacuum value, when the cell case expands, if the pressure difference between the first vacuum value and the second vacuum value is too large, the expansion force of the cell case may be too large, if the expansion force exceeds the maximum deformation allowable force of the cell case, the expansion and deformation of the cell case will be excessive, resulting in irreversible deformation, then a structure of the cell case is damaged, which is unable to adapt to the subsequent expansion and extrusion operations, and a performance of the cell case will also be damaged, therefore, when designing an internal and external pressure difference of the cell case, the maximum deformation allowable force of the cell case needs to be considered, the pressure difference between the first vacuum value and the second vacuum value is designed accordingly, while ensuring the expansion and compression of the cell case, the effective expansion and extrusion of the internal cell body of the cell 13 and accelerating of the rate and efficiency of the electrolyte infiltration, the irreversible deformation of the cell 13 may be avoided, thus ensuring the working performance and service life of the cell 13.

In an embodiment, a pressure difference between the second vacuum value and the first vacuum value is smaller than a maximum deformation allowable force of the cell case 134.

In an embodiment, a difference range of the second vacuum value and the first vacuum value is ranging from 10 KPa to 80 KPa.

In the embodiment, the maximum and minimum values of the difference range between the second vacuum value and the first vacuum value are limited, on the one hand, the problem that the expansion force of the cell case is insufficient and the cell case cannot be sufficiently expanded due to the difference value too small may be avoided, and on the other hand, the problem that the cell 13 is damaged due to the fact that the expansion force of the cell case is too large may be avoided.

In an embodiment, the first vacuum value is ranging from −10 KPa to −50 KPa.

In an embodiment, the second vacuum value is ranging from −20 KPa to −90 KPa.

In an embodiment, in S3, the pressure holding time is 0-120 s,

In an embodiment, in S4, the pressure holding time is 0-120 s,

In an embodiment, in S5, the set number of times is 0-10 times.

In an embodiment, in S6, a sealing temperature is 165° C.-195° C., and a sealing time is 2 s-7 s.

In an embodiment, in S6, the third vacuum value of the closed environment 3 is ranging from −80 KPa to −100 KPa.

By limiting various parameters in an electrolyte infiltration process of the cell, it may be ensured that all links in the electrolyte infiltration process of the cell are realized with reasonable parameters, so as to ensure the effective and smooth progress of a whole infiltration process of the cell, and ensure the cell effect and quality of the cell.

In an embodiment, in S6, the opening of the cell gas pocket 131 is sealed at the sealing area 132.

In an embodiment, in S6, first, the cell gas pocket 131 is clamped, and then the opening of the cell gas pocket is sealed at the sealing area 132.

In the embodiment, before sealing the opening of the cell gas pocket 131, a clamping area 133 of the cell gas pocket 131 is squeezed, clamped and sealed through the splints 11, so that the clamping area 133 of the gas pocket may become evener under the action of the splints 11, when sealing is carried out by a sealing head 10, the problem of bad sealing fold may be reduced, the sealing strength may be improved, and the risk of electrolyte leakage may be reduced.

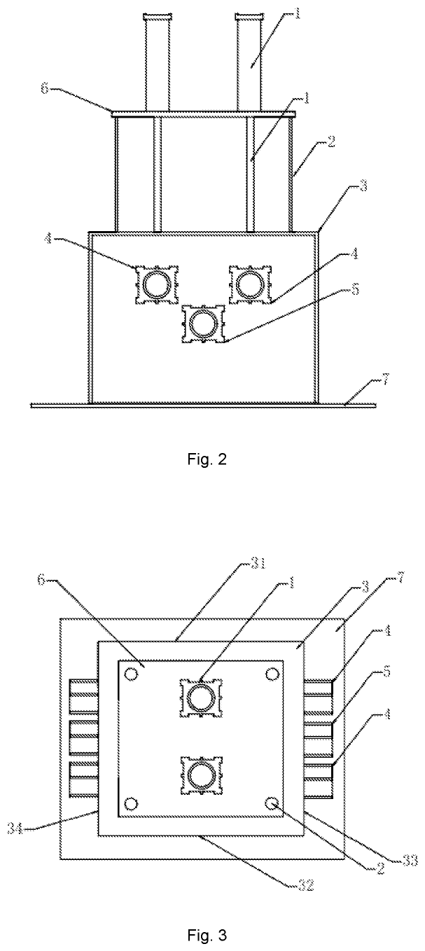

Referring to FIGS. 2-6, according to the embodiment of the disclosure, an infiltration apparatus applied to the electrolyte infiltration method for the pouch cell includes: a closed environment 3, having a sealed cavity configured to accommodate a cell assembly; splint cylinders 5, disposed on two opposite sides of the closed environment 3, each of the splint cylinders 5 includes a cylinder and a splint 11, the splint 11 is disposed at a telescopic end of the cylinder, and located in the sealed cavity, and two splints 11 disposed oppositely are configured for clamping or releasing an opening of a cell gas pocket 131.

In the embodiment, the infiltration apparatus includes the splint cylinders 5, and each of splint cylinders 5 includes a cylinder and a splint 11, in the electrolyte infiltration process of the cell, by utilizing cooperation of the cylinder and the splint 11, after the vacuum in the cell case 134 reaches the first vacuum value, the cell gas pocket 131 is clamped and sealed through two splints 11, in the sealing process, the cell gas pocket 131 is not sealed, when the two splints 11 are opened, the cell gas pocket 131 will also be opened therewith, here, the cell gas pocket 131 is sealed by the clamping force of the two splints 11, and the cell gas pocket 131 itself does not have the sealing effect intrinsically.

The purpose of the structure is to keep the pressure inside the cell case at the first vacuum value, thus facilitating the expansion and extrusion of the cell 13, improving the infiltration speed and effect of the electrolyte, meanwhile, after the cell 13 completes the infiltration, the splints 11 are released, so that an internal pressure of the cell case is in line with the sealing pressure of the cell 13, and then the cell 13 is sealed to realize convenient adjustment of the internal pressure of the cell case at different stages.

In an embodiment, a soft material layer 12 attaches to a surface of the splint 11, the sealing match effect of the two splints 11 on the cell gas pocket 131 may be improved by utilizing the flexibility of the soft material layer 12, so as to ensure the clamping and sealing effect of the two splints 11 on the cell gas pocket 131.

The soft material layer 12, for example, is made of silicone, rubber or foam.

In an embodiment, the closed environment 3 is defined by side plates, a top plate 35 and a bottom plate 7.

In an embodiment, the splint cylinders 5 are disposed on the side plates, and the cell gas pocket 131 may be clamped and sealed from two sides of the cell gas pocket 131 by utilizing the split cylinders 5, thus facilitating operation.

In an embodiment, the side plates include a rear side plate 31, a front side plate 32, a right side plate 33 and a left side plate 34, and the splint cylinders 5 are disposed on the left side plate 34 and the right side plate 33.

In an embodiment, the left side plate 34 and the right side plate 33 are further provided with sealing head cylinders 4 which are symmetrically disposed and configured for sealing the cell gas pocket 131.

In an embodiment, a telescopic end of each of the sealing head cylinders 4 is provided with a sealing head base 8, the sealing head base 8 is fixedly provided with a heating block 9 and a sealing head 10, and the heating block 9 is configured for heating the sealing head 10.

The sealing head cylinders 4 may heat and seal the sealing area 132 of the cell gas pocket 131, thus facilitating a sealing operation of the cell 13.

The infiltration apparatus further includes a lifting mechanism, the lifting mechanism includes a support plate 6, a lifting cylinder 1 and a guide rod 2, the guide rod 2 is fixedly disposed on the support plate 6, the closed environment 3 may slide along the guide of the guide rod 2, the lifting cylinder 1 is fixed on the support plate 6, and a telescopic end of the lifting cylinder 1 is connected with the top plate 35.

In an embodiment, a lifting mechanism includes a support plate 6, a lifting cylinder 1 and a guide rod 2, the support plate 6 is fixed on an installation base or an installation platform, and provides support for the arrangement of the lifting cylinder 1, the guide rod 2 and the closed environment 3, the guide rod 2 is fixed on the support plate 6, and plays a guide role on the rise and fall of the closed environment 3 through match with the lifting cylinder 1, the lifting cylinder 1 is fixed on the support plate 6, a telescopic end of the lifting cylinder 1 is connected with the top plate 35, and the lifting position of the closed environment 3 may be controlled by controlling a rod expansion of the lifting cylinder 1.

In order to ensure the sealing effect of the closed environment 3, sealing structures such as a seal rubber ring may be disposed at the matching position between the side plate and the bottom plate 7.

In an embodiment, the bottom of the sealed cavity of the closed environment 3 is provided with a cell fixing groove 14 for placing the cell assembly.

In an embodiment, a width of the cell fixing groove 14 is greater than that of the cell assembly, and a width difference between the two ranges (0, 30 mm].

In an embodiment, the width of the cell fixing groove 14 is greater than that of the cell assembly by 5 mm-20 mm.

In an embodiment, a clamping area of the splint 11 for the cell gas pocket 131 is any area of the cell gas pocket 131.

In an embodiment, a distance d between the sealing area of the cell gas pocket 131 and the clamping area of the cell gas pocket 131 is 5 mm-20 mm.

In an embodiment, the infiltration apparatus may only include a closed environment 3 and a splint cylinder 5, a sealing head cylinder 4 may also disposed at other positions, namely, the infiltration apparatus only completes an infiltration operation of the cell, and the sealing operation of the cell is carried out on other processes.

According to the embodiment of the disclosure, an electrolyte injection machine includes an electrolyte injection needle and the infiltration apparatus described above. The electrolyte injection needle is connected to the closed environment 3 of the infiltration apparatus, namely, the electrolyte injection needle is connected to the top plate 35.

In an embodiment, the infiltration apparatus may be integrated on the electrolyte injection machine, and includes a closed environment 3 and a splint cylinder 5, and does not include a sealing head cylinder 4 for sealing the cell 13, and a sealing operation of the cell is carried out on other processes.

It is apparent that the above-mentioned embodiments are only some, but not all, embodiments of the disclosure. All other embodiments obtained by those of ordinary skill in the art based on the embodiments of the disclosure without creative efforts shall fall within the protection scope of the disclosure.

It is to be noted that terms used herein are for the purpose of describing specific implementation modes only and are not intended to be limiting of exemplary implementation modes according to the disclosure. Unless otherwise directed by the context, singular forms of terms used herein are intended to include plural forms. Besides, it will be also appreciated that when terms “contain” and/or “include” are used in the description, it is indicated that features, steps, operations, devices, assemblies and/or a combination thereof exist.

The above is only some embodiments of the disclosure and is not intended to limit the disclosure. Those skilled in the art may make various modifications and variations. Any modifications, equivalent replacements, improvements and the like made within the spirit and principle of the disclosure shall fall within the scope of protection of the disclosure.

What is claimed is:

1. An electrolyte infiltration method for a pouch cell, comprising in sequence:
S1, placing a cell assembly after electrolyte injection in a closed environment, and enabling a cell gas pocket to be in an open state;
S2, setting the closed environment to a first vacuum value, and then closing the cell gas pocket;
S3, setting the closed environment to a second vacuum value, a pressure with the second vacuum value is maintained, wherein the second vacuum value is lower than the first vacuum value;
S4, setting the closed environment to a normal pressure, and the normal pressure is maintained;
S5, repeating S3 and S4 to a set number of times, and opening the cell gas pocket;
S6, setting the closed environment to a third vacuum value, and sealing an opening of the cell gas pocket.

2. The electrolyte infiltration method for the pouch cell as claimed in claim 1, wherein the closed environment is a vacuum device.

3. The electrolyte infiltration method for the pouch cell as claimed in claim 1, wherein a pressure difference between the second vacuum value and the first vacuum value is smaller than a maximum deformation allowable force of a cell case.

4. The electrolyte infiltration method for the pouch cell as claimed in claim 1, wherein a difference range of the second vacuum value and the first vacuum value is from 10 KPa to 80 KPa.

5. The electrolyte infiltration method for the pouch cell as claimed in claim 1, wherein in S2, the first vacuum value is ranging from −10 KPa to −50 KPa; and/or, wherein in S3, the second vacuum value is ranging from −20 KPa to −90 KPa.

6. The electrolyte infiltration method for the pouch cell as claimed in claim 1, wherein in S6, the third vacuum value of the closed environment is ranging from −80 KPa to −100 KPa.

7. The electrolyte infiltration method for the pouch cell as claimed in claim 1, wherein in S3, a pressure holding time is 0-120 s; and/or, wherein in S4, a pressure holding time is 0-120 s.

8. The electrolyte infiltration method for the pouch cell as claimed in claim 1, wherein in S5, the set number of times is 0-10 times; and/or, wherein in S6, a sealing temperature is ranging from 165° C. to 195° C., and/or a sealing time is 2 s-7 s.

9. The electrolyte infiltration method for the pouch cell as claimed in claim 1, wherein S6 comprises:
sealing the opening of the cell gas pocket; or, clamping the cell gas pocket, and then sealing the opening of the cell gas pocket.

10. An infiltration apparatus applied to the electrolyte infiltration method for the pouch cell as claimed in claim 1, comprising:
the closed environment, having a sealed cavity configured to accommodate the cell assembly;
splint cylinders, disposed on two opposite sides of the closed environment, each of the splint cylinders comprises a cylinder and a splint, the splint is disposed at a telescopic end of the cylinder, and located in the sealed cavity, and two splints disposed oppositely are configured for clamping or releasing the opening of the cell gas pocket.

11. The infiltration apparatus as claimed in claim 10, wherein a distanced between a sealing area of the cell gas pocket and a clamping area of the cell gas pocket is 5-20 mm.

12. The infiltration apparatus as claimed in claim 10, wherein a soft material layer attaches to a surface of the splint.

13. The infiltration apparatus as claimed in claim 10, wherein the closed environment is comprised by side plates, a top plate and a bottom plate; and the splint cylinders are disposed on the side plates.

14. The infiltration apparatus as claimed in claim 13, wherein the side plates comprise a rear side plate, a front side plate, a right side plate and a left side plate, and the splint cylinders are disposed on the left side plate and the right side plate.

15. The infiltration apparatus as claimed in claim 14, wherein the left side plate and the right side plate are further provided with sealing head cylinders which are symmetrically disposed and configured for sealing the cell gas pocket.

16. The infiltration apparatus as claimed in claim 15, wherein a telescopic end of the sealing head cylinder is provided with a sealing head base, the sealing head base is fixedly with a heating block and a sealing head, and the heating block is configured for heating the sealing head.

17. The infiltration apparatus as claimed in claim 13, wherein the infiltration apparatus further comprises a lifting mechanism, the lifting mechanism comprises a lifting cylinder and a guide rod, and the closed environment is able to slide along the guide rod under an action of the lifting cylinder.

18. The infiltration apparatus as claimed in claim 10, wherein a bottom of the sealed cavity of the closed environment is provided with a cell fixing groove for placing the cell assembly.

19. An electrolyte injection machine, comprising an electrolyte injection needle, and further comprising infiltration apparatus as claimed in claim 10, and the electrolyte injection needle is connected to the closed environment of the infiltration apparatus.
